(19) United States
(12) Patent Application Publication
(10) Pub. No.: US 2026/0221871 A1
(43) Pub. Date: Jul. 30, 2026

(54) RESONANT CONVERTER CIRCUIT

(71) Applicant: Renesas Design (UK) Limited, Bourne End (GB)

(72) Inventors: Guang FENG, San Jose, CA (US); Yong LI, San Jose, CA (US)

(73) Assignee: Renesas Design (UK) Limited, Bourne End (GB)

(21) Appl. No.: 19/038,994

(22) Filed: Jan. 28, 2025

(51) Int. Cl. H02M 3/00; H02M 1/00; H02M 3/335

(52) U.S. Cl. CPC H02M 3/01; H02M 1/0058; H02M 3/33569

(57) ABSTRACT

A resonant converter circuit configured to receive an input voltage at an input port and output an output voltage at an output port, operating in a discontinuous conduction mode, the resonant converter circuit including: a main switch; a reset switch; a resonant tank circuit connected across the reset switch, the resonant tank circuit including an inductive device; and a first node connected between the main switch and the reset switch. The resonant converter circuit is configured to: calculate a turn on time for the main switch; and turn on the main switch at the turn on time. A turn on time for the reset switch is determined based on the turn on time for the main switch, such that the reset switch turns on only after the main switch has been turned on.

### FIELD

The present disclosure relates to a resonant converter circuit.

### BACKGROUND

It is known that during medium to light load operation, resonant converters do not usually operate in a continuous conduction mode (CCM). Rather, resonant converters operating in a discontinuous conduction mode (DCM) or burst mode.

During a DCM or burst mode, it is known to insert a reset switch turn on pulse before turning on a main switch, in order to make the primary transformer current go negative. When the reset switch is turned off, the negative transformer current helps to discharge the parasitic capacitance, Coss, of the main switch. When the MS Coss is fully or partially discharged, a voltage across a node between the main switch and reset switches will approximate the input voltage when the resonant tank is on the low side, or close to 0V when the resonant tank is on the high side. Thus, the main switch achieves a Zero Voltage Switching (ZVS) turn on.

This existing method suffers with a reduced dynamic load response because the extra reset switch turn on pulse delays the converter response to deliver energy to the secondary side when a dynamic load occurs. This happens especially when the load is changed from light to heavy, and requires the resonant converter to react quickly to avoid a large output voltage.

Thus, the insertion of the extra reset switch turn on pulse causes a delay in the turning on of the main switch, when this turn on, as defined by the control loop, should be instant. This causes a decrease in system performance by increasing duty cycle loss, lowering switching frequency, and delaying control loop response.

Additionally, the existing method causes a extra amount of energy loss. This is because the flow of negative inductor current causes circulation energy and extra conduction loss, offsetting the benefit of the switching loss reduction.

### SUMMARY

According to a first aspect of the disclosure, there is provided a resonant converter circuit configured to receive an input voltage at an input port and output an output voltage at an output port, operating in a discontinuous conduction mode, the resonant converter circuit comprising:

a main switch;

a reset switch;

a resonant tank circuit connected in parallel with the reset switch, the resonant tank circuit comprising an inductive device; and

a first node connected between the main switch and the reset switch;

wherein the resonant converter circuit is configured to:

calculate a turn on time for the main switch; and

turn on the main switch at the turn on time;

wherein a turn on time for the reset switch is determined based on the turn on time for the main switch, such that the reset switch turns on only after the main switch has been turned on.

Optionally, the turn on time for the main switch is calculated for each switching cycle of the discontinuous conduction mode.

Optionally, the resonant converter circuit is a full bridge or a half bridge resonant converter circuit.

Optionally, the resonant converter circuit is an asymmetrical circuit.

According to a second aspect of the disclosure, there is provided a resonant converter circuit configured to receive an input voltage at an input port and output an output voltage at an output port, operating in a discontinuous conduction mode, the resonant converter circuit comprising:

a main switch;

a reset switch;

a resonant tank circuit connected across the reset switch, the resonant tank circuit comprising an inductive device; and

a first node connected between the main switch and the reset switch;

wherein the resonant converter circuit is configured to:

calculate a turn on time for the main switch;

monitor a voltage across the first node;

determine that a first condition is met when a rate of change of the voltage across the first node is within a first predefined threshold of zero;

determine that a second condition is met when a current time is within a second predefined threshold of the turn on time; and

if the first condition and the second condition are met, turn on the main switch.

Optionally, wherein a turn on time for the reset switch is determined based on when the main switch is turned on, such that the reset switch turns on only after the main switch has been turned on.

Optionally, when the main switch is connected between the reset switch and the input port, determining that the first condition is met comprises:

determining that the voltage across the first node has reached a maximum value.

Optionally, determining that the voltage across the first node has reached the maximum value comprises:

determining that the rate of change of the voltage across the first node has changed from positive to negative.

Optionally, determining that the voltage across the first node has reached the maximum value comprises:

comparing the voltage across the first node with a reference voltage and generating a first signal representative of the comparison; and

detecting when the voltage across the first node reaches the maximum based on the first signal.

Optionally, when the reset switch is connected between the main switch and the input port, determining that the first condition is met comprises:

determining that the voltage across the first node has reached a minimum value.

Optionally, determining that the voltage across the first node has reached a minimum value comprises:

determining that the rate of change of the voltage across the first node has changed from negative to positive .

Optionally, determining that the voltage across the first node has reached a minimum value comprises:

comparing the voltage across the first node with a reference voltage and generating a second signal representative of the comparison; and

detecting when the voltage across the first node reaches the minimum based on the second signal.

Optionally, the rate of change of the voltage across the first node is monitored by detecting a voltage at the first node using a voltage sensing device.

Optionally, the rate of change of the voltage across the first node is monitored by detecting a voltage at the first node indirectly using an auxiliary winding circuit.

Optionally, the resonant converter circuit is a full bridge or a half bridge resonant converter circuit.

Optionally, the resonant converter circuit is an asymmetrical circuit.

According to a third aspect of the disclosure, there is provided a method of operating a resonant converter circuit, the resonant converter circuit configured to receive an input voltage at an input port and output an output voltage at an output port, operating in a discontinuous conduction mode, the method comprising:

calculating a turn on time for a main switch of the resonant converter circuit;

turning on the main switch at the calculated turn on time.

Optionally, further comprising:

monitoring a voltage across a first node of the resonant converter circuit;

determining that a first condition is met when a rate of change of the voltage across the first node is within a first predefined threshold of zero;

determining that a second condition is met when a current time is within a second predefined threshold of the turn on time; and

if the first condition and the second condition are met, turning on the main switch.

### BRIEF DESCRIPTION OF THE DRAWINGS

The disclosure is described in further detail below by way of example and with reference to the accompanying drawings, in which:

FIG. 1 is a block diagram representing a circuit;

FIG. 2 is a flowchart representing a method of operating a circuit;

FIG. 3 is a flowchart representing a method of operating a circuit;

FIG. 4 is a block diagram representing a circuit;

FIG. 5A is a circuit diagram representing a resonant converter circuit;

FIG. 5B is a circuit diagram representing a resonant converter circuit;

FIG. 6A is a graph representing the operation of a resonant converter circuit;

FIG. 6B is a graph representing the operation of a resonant converter circuit;

FIG. 7A is a circuit diagram representing a resonant converter circuit according to an example; and

FIG. 7B is a circuit diagram representing a resonant converter circuit according to another example.

### DETAILED DESCRIPTION

The current disclosure relates to a resonant converter circuit and a timing control method for maintaining efficiency and dynamic performance at medium to light load.

The current disclosure relates to a resonant converter circuit operating in a Discontinuous Conduction Mode (hereinafter referred to as a DCM mode). The DCM mode covers operation modes such as Pulse Width Modulation (PWM) mode, Pulse Frequency Modulation (PFM) mode, combination PWM and PFM modes, valley/peak skip modes. In these modes, resonant VHB ringing will present between two adjunct switching cycles.

In the current disclosure, a “resonant converter circuit” refers to any resonant converter circuit. For example, included are half bridge and full bridge resonant converters, such as Asymmetrical Half Bridge (AHB) flyback converters, inductor-inductor-capacitor type resonant converters, LLCs, and the like.

In the current disclosure, any “switch”, “switching device”, or “switching element” may be a transistor device, such as a MOSFET, or any other suitable switching device or element.

In the current disclosure, “connect” or “connected” refers to an electrical communication between two or more components either directly (for example, via wires) or indirectly. “Switchably connected” refers to an electrical connection that may be formed by turning a switch on and thus forming a connection between two or more components.

The figures show a specific configuration, but it should be understood that it is intended that the scope of the disclosure include minor changes to components and layout, such as replacements to components of similar function.

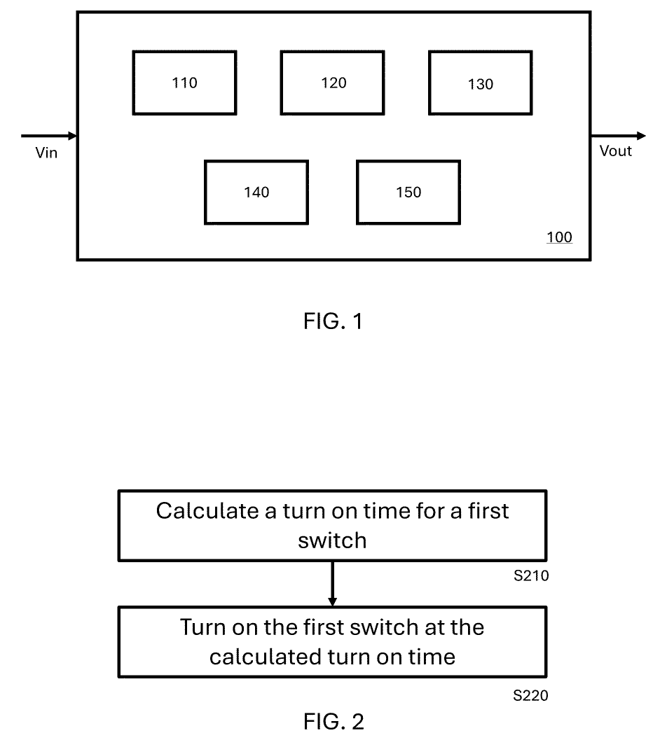

FIG. 1 shows a block diagram representing a resonant converter circuit 100 according to the current disclosure.

The resonant converter circuit 100 comprises a main switch 110, a reset switch 120, and a resonant tank 130. The resonant converter circuit 100 also comprises an input port for receiving an input voltage, Vin, and an output port for outputting an output voltage, Vout. The resonant converter circuit 100 may also comprise a control circuit 140 and a sensor device 150.

The resonant tank 130 is a circuit configured to convert the input voltage into the output voltage, and is connected in parallel to the reset switch. The resonant tank 130 comprises an inductive device. The resonant tank 130 may also comprise a capacitive device (such as a capacitor or any other suitable charge-storing device).

The resonant converter circuit 100 may comprise a first node disposed between the main switch 110 and the reset switch 120.

The control circuit 140 may be a device or circuit configured to control a switching sequence of the main switch and the reset switch. The control circuit 140 may be a device that may be an internal component of the resonant converter circuit 100 or may be an external component communicatively connected to the resonant converter circuit 100.

The sensor device 150 may be a device configured to sense a voltage at a point in the circuit. For example, the sensor device 150 may be configured to measure a voltage across a first node of the resonant converter circuit 100.

The resonant converter circuit 100 may be configured to provide a timing control method for the main switch 110 and the reset switch 120 that does not use an extra second (reset) switch on pulse during a DCM mode. The timing control method will now be described in more detail.

FIG. 2 is a flowchart illustrating a method of operating a resonant converter circuit such as the resonant converter circuit 100 shown in FIG. 1. The method is a timing control method.

At step S210, a turn on time for a main switch of the resonant converter circuit is calculated (or predefined, or predetermined).

The turn on time may be calculated (or defined or determined) before each switching cycle. The turn on time may be independent of resonant characteristics of the resonant converter circuit.

At step S220, at the calculated turn on time, the main switch is turned on.

The main switch may be directly turned on at the turn on time. That is, regardless of resonant characteristics of the resonant converter circuit, the main switch is turned on at the calculated turn on time.

This method does not require the turning on of the reset switch to provide a pulse before the main switch is turned on. Thus, it is the case that a turn on time for the reset switch is determined based on the turn on time of the main switch, such that the reset switch turns on only after the main switch has been turned off.

In more detail, the reset switch may be turned on after a predefined delay time after the main switch has been turned off.

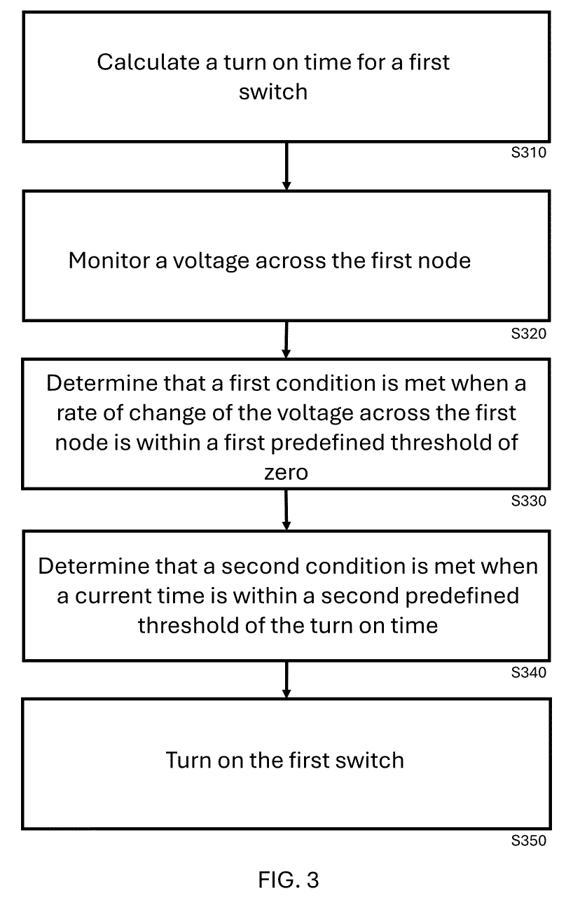

FIG. 3 is a flowchart illustrating an alternative method of operating a resonant converter circuit such as the resonant converter circuit 100 shown in FIG. 1. The method is a timing control method.

At step S310, a turn on time for a main switch of the resonant converter circuit 100 is calculated.

The turn on time may be calculated (or defined or determined) before each switching cycle. The turn on time may be dependent of resonant characteristics of the resonant converter circuit.

At step S320, a voltage across a first node of the resonant converter circuit is monitored.

The first node may be a node connected between the main switch and the reset switch (for example, main switch 110 and reset switch 120 of FIG. 1) of the resonant converter circuit.

The voltage may be monitored directly, by a sensing device or the like; for example, a voltage sensing device may be used to detect a voltage value at the first node and generate a signal indicating said voltage value. The signal may then be transmitted to a controller or the like to determine a rate of change of the voltage across the first node.

Alternatively, the voltage at the first node may be detected indirectly, using an auxiliary winding circuit or the like; for example, an auxiliary winding circuit may be used to detect a voltage value at the first node and generate a signal indicating said voltage value. The signal may then be transmitted to a controller or the like to determine a rate of change of the voltage across the first node.

At step S330, it is determined whether a first condition is met when a rate of change of the voltage across the first node is within a first predefined threshold of zero. The first predefined threshold represents range of values around zero that are relatively close enough to zero for the circuit to function as intended, as would be understood by the skilled person.

That is, it is determined whether the rate of change of the voltage across the first node is close to zero, and therefore whether the voltage across the first node has hit a maximum (peak) or minimum (valley) value. This may be determined by determining whether the rate of change has changed from positive to negative (in the case of determining that a maximum has been reached) or from negative to positive (in the case of determining that a minimum has been reached). The voltage across the first node may hit a maximum value in the case that the resonant tank is connected at a low side of the resonant converter circuit; the maximum value may be the same as the value of the input voltage (Vin). The voltage across the first node may hit a minimum value in the case that the resonant tank is connected at a high side of the resonant converter circuit; the minimum value may be a value of 0V.

At step S340, it is determined whether a second condition is met when a current time is within a second predefined threshold of the turn on time. The second predefined threshold represents an amount of time before and after the turn on time wherein it remains appropriate for the main switch to be turned on. The second predefined threshold may be set for each operating period of the circuit.

That is, it is determined whether the current time is close to the turn on time. “Close” to the turn on time means at or reasonably around the calculated time, as the skilled person would understand. Thus, it may be determined that the current time is exactly the calculated time or is close to the calculated time.

At step S350, if both the first condition and the second condition are met, the main switch is turned on.

When both the first condition and the second condition are met, it is an ideal time for the main switch to turn on, without requiring a short reset switch turn on pulse beforehand. Thus, dynamic load response is preserved by turning on the main switch directly.

Additionally, a turn on time may be determined for the reset switch based on the turn on time of the main switch, such that the reset switch does not turn on before the main switch has been turned on. The turn on time for the reset switch may be determined based either on the calculated turn on time for the main switch, or the actual time that the main switch turns on.

In more detail, the reset switch may be turned on after a predefined delay time after the main switch has been turned off. Alternatively, a similar method to determining a turn on time for the main switch may be used for determining a turn on time for the main switch.

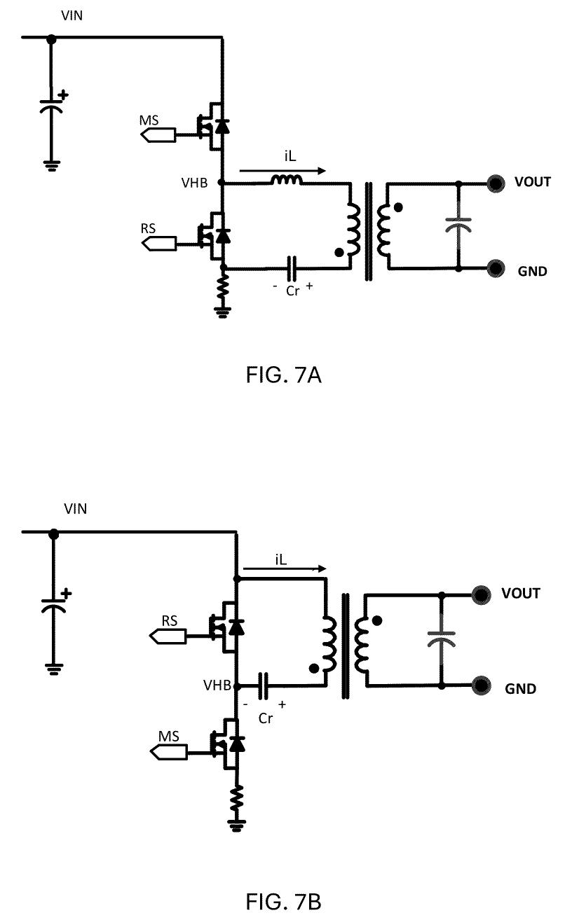

That is, a rate of change of the voltage may be monitored to determine when a maximum or minimum is reached. For example, a turn on time for the reset switch may be determined based on the voltage across the first node reaching a minimum value in the case that the resonant tank is connected at a low side of the resonant converter circuit (as shown in FIG. 7A); the minimum value may be 0V. In another example, a turn on time for the reset switch may be determined based on the voltage across the first node may reaching a maximum value in the case that the resonant tank is connected at a high side of the resonant converter circuit (as shown in FIG. 7B); the maximum value may be a value equivalent to the input voltage (Vin).

In more detail, determining when a minimum or maximum is reached may comprise comparing the voltage across the first node to a threshold close to the minimum or maximum value. For example, to determine when a minimum is reached, the voltage across the first node may be compared to a threshold close to 0V (for example, 1V). Then, when the voltage across the first node is less than 1V, the reset switch may be turned on.

In the case that it must be determined when a maximum is reached, the voltage across the first node must be compared to input voltage, Vin. In one example, this may be done by using an IC pin to monitor the input voltage. A threshold may then be set based on the sensed input voltage. For example, the threshold may be 90% of the input voltage. Thus, when the voltage across the first node is determined to have reached at least 90% of the sensed input voltage, it may be determined that a maximum is reached and the reset switch may be turned on.

In another example, it may be determined that the maximum is reached by sampling the voltage across the first node in a previous switching cycle at a point in which the reset switch is turned on. Then, a threshold may be set at 90% of the sampled voltage. When the voltage across the first node in the current cycle reaches 90% of the sampled voltage, the reset switch may be turned on.

It should be understood that each of the methods for turning on the reset switch described above apply only once the main switch has been turned on according to the methods described herein (and has turned off again).

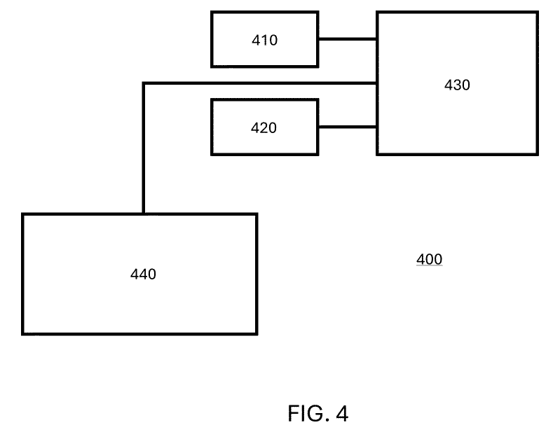

FIG. 4 provides a more detailed block diagram example of a resonant converter circuit according to the current disclosure. For example, FIGS. 1 and 4 may represent the same resonant converter circuit. Additionally, the resonant converter circuits 100 and 400 may be configured to carry out the methods described by reference to FIGS. 2 and 3.

The resonant converter circuit 400 is configured to receive an input voltage at an input port and output an output voltage at an output port, operating in a discontinuous conduction mode.

The resonant converter circuit 400 of FIG. 4 comprises a main switch 410 (which may be the same as, for example, switch 110 of FIG. 1), a reset switch 420 (which may be the same as, for example, switch 120 of FIG. 2), a resonant tank 430 (which may be the same as, for example, resonant tank 130 of FIG. 3) connected in parallel with the reset switch, the resonant tank comprising an inductive device; and a first node (not shown) connected between the main switch 410 and the reset switch 420. The resonant converter circuit 400 may also comprise a controller (or processing unit or the like) 440 that is configured to control a timing control method (and/or switching sequence) for the main 410 and reset 420 switches.

As shown in FIG. 4, the main 410 and reset 420 switches are each connected to the resonant tank 430. The first node, connected between the main 410 and reset 420 switch, is used, as described by reference to FIG. 3, to monitor voltage. This may be done by connecting the resonant tank 430 to the control circuit 440 via the first node, allowing a signal representing the voltage at the first node to be processed by the control circuit 440. The signal may represent a comparison between the voltage across the first node and a reference voltage.

The rate of change of the voltage across the first node may be monitored by detecting a voltage at the first node using a voltage sensing device. Alternatively, the rate of change of the voltage across the first node may be monitored by detecting a voltage at the first node indirectly, using an auxiliary winding circuit.

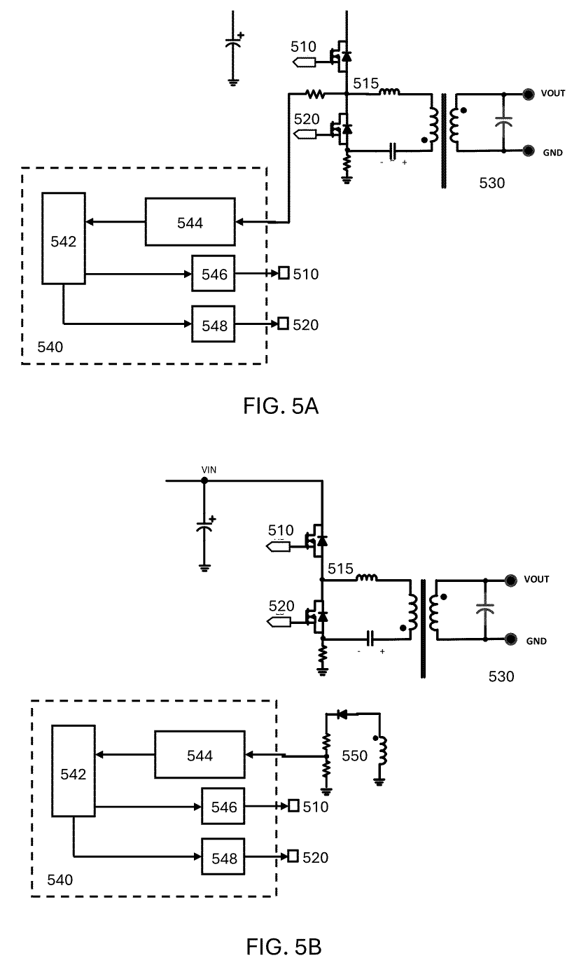

The control circuit may form part of the resonant converter circuit 400 as an internal component (for example, an IC) or may be communicatively connected to the resonant converter circuit 400 as an external component. These scenarios are exemplified in FIGS. 5A and 5B as discussed below.

FIG. 5A is a diagram representing a resonant converter circuit 500 according to the current disclosure (for example, the resonant converter circuit 500 may be the same or similar to the resonant converter circuits 100 and 400 as discussed by reference to FIGS. 1 and 4, and may carry out the methods described by reference to FIGS. 2 and 3). The resonant converter circuit 500 shown in FIG. 5A is an asymmetric half bridge resonant converter in which the resonant tank is connected at the low-side (in parallel with the low-side switch), however it should be understood that this is merely exemplary and other configurations are also envisioned. For example, the resonant converter circuit 500 may be a full bridge resonant converter, or the resonant tank may be connected at the high-side (in parallel with the high-side switch). Example configurations are shown in FIGS. 7A and 7B. FIG. 7A shows an example of an asymmetric half bridge resonant converter wherein the resonant tank is connected at the low side, such that the main switch is connected between the input port and the reset switch, wherein the reset switch is the low side switch that the resonant tank is connected in parallel to (or connected across). FIG. 7B shows an alternative example of an asymmetric half bridge resonant converter wherein the resonant tank is connected at the high side, such that the reset switch is connected between the input port and the main switch, wherein the reset switch is the high side switch that the resonant tank is connected in parallel to (or connected across).

Connected between the main switch 510 and a reset switch 520 is a resonant tank 530 which comprises an inductive device, as well as a capacitive device and a resistive device. The resonant tank 530 is configured to convert the input voltage, Vin, into the output voltage, Vout.

The control circuit 540 comprises a controller 542, a signal processor 544 for processing a signal received from the first node 515, a high side driver 546 for operating a high side switch 510, and a low side driver 548 for operating a low side switch 520. The control circuit 540 may additionally comprise a level shifter (not shown). The high side switch 510 or the low side switch 520 may be a main switch or reset switch, depending on where the resonant tank 530 is connected. The switch that the resonant tank 530 is connected in parallel to is a reset switch and the remaining switch is a main switch.

In the case that the resonant tank 530 is connected in parallel with the low side switch 520, and therefore the low side switch 520 is a reset switch and the high side switch 510 is a main switch, the high side driver 546 is configured to output a first control signal to the main switch 510, wherein the first control signal controls the main switch 510 to turn on or off. The high side driver 546 may be configured to output the first control signal in response to receiving a signal from the controller 542 that is indicative that the first and second conditions have been met, thus instructing the high side driver 546 to control the main switch 510 to turn on.

The low side driver 548 is configured to output a second control signal to the reset switch 520, wherein the second control signal controls the reset switch 520 to turn on or off.

It should be understood that it may also be the case that the resonant tank 530 is connected in parallel to the high side switch 510, in which case the same would apply, but with the high side switch 510 acting as reset switch and the low side switch 520 acting as main switch and, thus, the roles of the high side driver 546 and the low side driver 548 changed accordingly.

FIG. 5A shows a resonant converter circuit 500 in which a control circuit 540 is directly connected to the resonant converter circuit 500. The control circuit 540 is connected between a high side switch 510 and a low side switch 520 at a first node 515.

FIG. 5B shows a resonant converter circuit 500 in which a control circuit 540 is indirectly connected to the resonant converter circuit 500, wherein the control circuit 540 is connected via an auxiliary winding circuit 550.

The control circuit 540 comprises a controller 542, a signal processor 544 for processing a signal received from the auxiliary winding circuit 550, a high side driver for operating the high side switch 510, and a low side driver for operating the low side switch 520. The control circuit 540 may additionally comprise a level shifter (not shown).

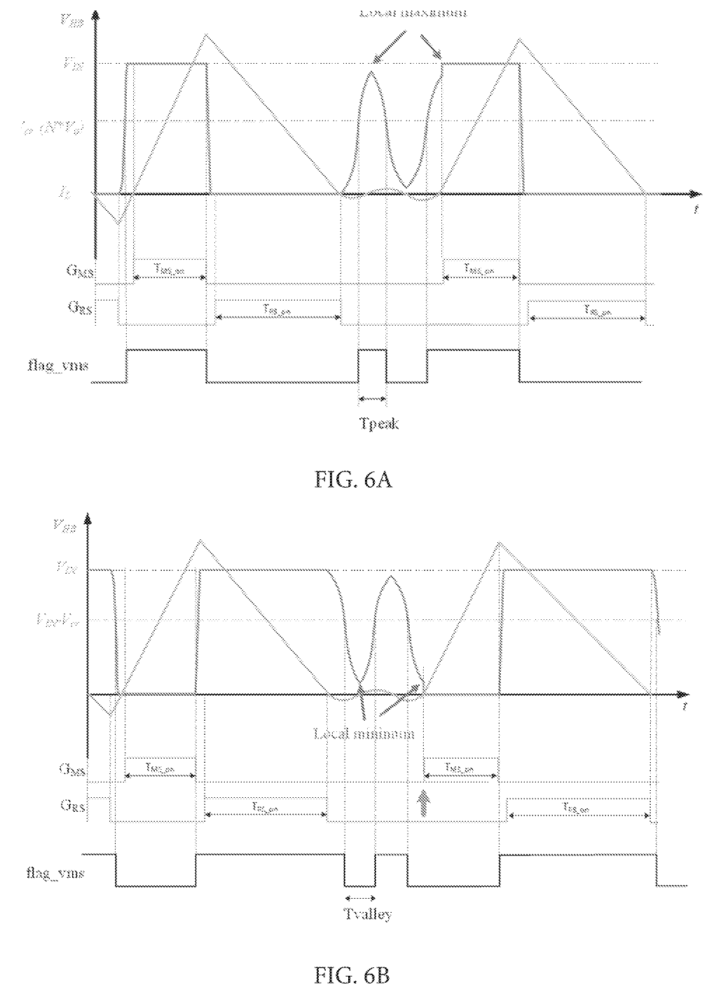

FIGS. 6A and 6B are graphs each representing the operation of a resonant converter circuit according to the current disclosure.

FIG. 6A illustrates an operation of the resonant converter circuit wherein the resonant tank is connected on the low-side of the circuit, in parallel to the low side switch.

It can be seen that after the reset switch (low side) switches off and before the main switch (high side) switches on, the input voltage begins to oscillate. The ideal time to switch the main switch on is when the input voltage is at a maximum value.

Using the method described herein, a signal, flag_vms, indicates when the input voltage is at a maximum value. When the input voltage it at, or approaching, the maximum value, it can be seen that the main switch turns on.

FIG. 6B illustrates an operation of the resonant converter circuit wherein the resonant tank is connected on the high-side of the circuit.

It can be seen that after the reset switch (high side) switches off and before the main switch (low side) switches on, the input voltage begins to oscillate. The ideal time to switch the main switch on is when the input voltage is at a minimum value.

Using the method described herein, a signal, flag_vms, indicates when the input voltage is at a minimum value. When the input voltage it at, or approaching, the minimum value, it can be seen that the main switch turns on.

Example circuit configurations corresponding to the graphs of FIGS. 6A and 6B are shown in FIG. 7A and 7B. FIG. 7A shows an example of an asymmetric half bridge resonant converter wherein the resonant tank is connected at the low side, such that the main switch is connected between the input port and the reset switch, wherein the reset switch is the low side switch that the resonant tank is connected in parallel to (or connected across). FIG. 7B shows an alternative example of an asymmetric half bridge resonant converter wherein the resonant tank is connected at the high side, such that the reset switch is connected between the input port and the main switch, wherein the reset switch is the high side switch that the resonant tank is connected in parallel to (or connected across).

Various improvements and modifications can be made to the above without departing from the scope of the disclosure.

1. A resonant converter circuit configured to receive an input voltage at an input port and output an output voltage at an output port, operating in a discontinuous conduction mode, the resonant converter circuit comprising:
a main switch;
a reset switch;
a resonant tank circuit connected across the reset switch, the resonant tank circuit comprising an inductive device; and
a first node connected between the main switch and the reset switch;
wherein the resonant converter circuit is configured to:
calculate a turn on time for the main switch; and
turn on the main switch at the turn on time; and
wherein a turn on time for the reset switch is determined based on the turn on time for the main switch, such that the reset switch turns on only after the main switch has been turned on.

2. The resonant converter circuit of claim 1, wherein the turn on time for the main switch is calculated for each switching cycle of the discontinuous conduction mode.

3. The resonant converter circuit of claim 1, wherein the resonant converter circuit is a full bridge or a half bridge resonant converter circuit.

4. The resonant converter circuit of claim 3, wherein the resonant converter circuit is an asymmetrical circuit.

5. A resonant converter circuit configured to receive an input voltage at an input port and output an output voltage at an output port, operating in a discontinuous conduction mode, the resonant converter circuit comprising:
a main switch;
a reset switch;
a resonant tank circuit connected across either the reset switch, the resonant tank circuit comprising an inductive device; and
a first node connected between the main switch and the reset switch;
wherein the resonant converter circuit is configured to:
calculate a turn on time for the main switch;
monitor a voltage across the first node;
determine that a first condition is met when a rate of change of the voltage across the first node is within a first predefined threshold of zero;
determine that a second condition is met when a current time is within a second predefined threshold of the turn on time; and
if the first condition and the second condition are met, turn on the main switch.

6. The circuit of claim 5, wherein a turn on time for the reset switch is determined based on when the main switch is turned on, such that the reset switch turns on only after the main switch has been turned on.

7. The circuit of claim 5, wherein, when the main switch is connected between the reset switch and the input port, determining that the first condition is met comprises:
determining that the voltage across the first node is has reached a maximum value.

8. The circuit of claim 7, wherein determining that the voltage across the first node has reached the maximum value comprises:
determining that the rate of change of the voltage across the first node has changed from positive to negative.

9. The circuit of claim 5, wherein determining that the voltage across the first node has reached the maximum value comprises:
comparing the voltage across the first node with a reference voltage and generating a first signal representative of the comparison; and
detecting when the voltage across the first node reaches the maximum based on the first signal.

10. The circuit of claim 5, wherein, when the reset switch between the main switch and the input port, determining that the first condition is met comprises:
determining that the voltage across the first node has reached a minimum value.

11. The circuit of claim 10, wherein determining that the voltage across the first node has reached a minimum value comprises:
determining that the rate of change of the voltage across the first node has changed from negative to positive.

12. The circuit of claim 10, wherein determining that the voltage across the first node has reached a minimum value comprises:
comparing the voltage across the first node with a reference voltage and generating a second signal representative of the comparison; and
detecting when the voltage across the first node reaches the minimum based on the second signal.

13. The circuit of claim 5, wherein the rate of change of the voltage across the first node is monitored by detecting a voltage at the first node using a voltage sensing device.

14. The circuit of claim 5, wherein the rate of change of the voltage across the first node is monitored by detecting a voltage at the first node indirectly using an auxiliary winding circuit.

15. The resonant converter circuit of claim 5, wherein the resonant converter circuit is a full bridge or a half bridge resonant converter circuit.

16. The resonant converter circuit of claim 15, wherein the resonant converter circuit is an asymmetrical circuit.

17. A method of operating a resonant converter circuit, the resonant converter circuit configured to receive an input voltage at an input port and output an output voltage at an output port, operating in a discontinuous conduction mode, the method comprising:
calculating a turn on time for a main switch of the resonant converter circuit; and
turning on the main switch at the calculated turn on time,
wherein a turn on time for the reset switch is determined based on the turn on time for the main switch, such that the reset switch turns on only after the main switch has been turned on.

18. The method of claim 17, further comprising:
monitoring a voltage across a first node of the resonant converter circuit;
determining that a first condition is met when a rate of change of the voltage across the first node is within a first predefined threshold of zero;
determining that a second condition is met when a current time is within a second predefined threshold of the turn on time; and
if the first condition and the second condition are met, turning on the main switch.
